(19) United States
(12) Patent Application Publication
(10) Pub. No.: US 2025/0074119 A1
(43) Pub. Date: Mar. 6, 2025

(54) TIRE

(71) Applicant: BRIDGESTONE CORPORATION, Chuo-ku, Tokyo (JP)

(72) Inventor: Shinya SUGISAWA, Chuo-ku, Tokyo (JP)

(73) Assignee: BRIDGESTONE CORPORATION, Chuo-ku, Tokyo (JP)

(21) Appl. No.: 18/684,836

(22) PCT Filed: Jun. 17, 2022
(86) PCT No.: PCT/JP2022/024414

§ 371 Date: Feb. 20, 2024

(30) Foreign Application Priority Data
Sep. 22, 2021 (JP) 2021-154870

(51) Int. Cl. B60C 11/12; B60C 11/03

(52) U.S. Cl. CPC B60C 11/1281; B60C 11/0306; B60C 2011/129

(57) ABSTRACT

Provided is a tire characterized in that at least one shoulder groove 4 is provided in shoulder land portions 3a and 3b, which are divided by the circumferential main grooves 2a located at the outermost side in the tire width direction and a tread edge TE, the shoulder groove 4 has a widened section 4a on the groove bottom side where a groove width is larger than that on the tread surface 1 side, the shoulder groove 4 extends along the tire width direction on the tread surface 1, and a maximum width portion Pw in the tire radial direction of the widened section 4a extends at an angle of 25° or more with respect to the tire width direction in a plane view of the tread surface.

### TECHNICAL FIELD

This disclosure relates to a tire.

This application claims priority based on Patent Application No. 2021-154870 filed in Japan on Sep. 22, 2021, the entire content thereof is incorporated herein by reference.

### BACKGROUND

Tires having sipes whose width at the bottom portion is widened in order to control the decrease in drainage performance of the tire when tire wear has progressed, have been disclosed (Patent Document 1).

### CITATION LIST

### Patent Literature

PTL 1: JP 2018-111421 A

### SUMMARY

### Technical Problem

However, there is room for further improvement in the prior art with regard to drainage performance when tire wear has progressed.

Therefore, the purpose of the present disclosure is to provide a tire with sufficient drainage performance even when tire wear has progressed.

### Solution to Problem

The gist of the present disclosure is as follows.

A tire having a plurality of circumferential main grooves extending in the tire circumferential direction on a tread surface,
at least one shoulder groove is provided in a shoulder land portion, which is divided by the circumferential main groove located at the outermost side in the tire width direction and a tread edge,
the shoulder groove has a widened section on the groove bottom side where a groove width is larger than that on the tread surface side,
the shoulder groove extends along the tire width direction on the tread surface, and
a maximum width portion in the tire radial direction of the widened section extends at an angle of 25° or more with respect to the tire width direction in a plane view of the tread surface.

### Advantageous Effect

The present disclosure can provide a tire with sufficient drainage performance even when tire wear has progressed.

### BRIEF DESCRIPTION OF THE DRAWINGS

In the accompanying drawings:

FIG. 1 schematically illustrates the contact patch of a tire according to the first embodiment of this disclosure, viewed in the tire axial direction;

FIG. 2 is a cross-sectional view along the line A-A in FIG. 1;

FIG. 3 is a schematic perspective view for explaining the shape of the shoulder groove; and

FIG. 4 schematically illustrates the contact patch of a tire according to the second embodiment of this disclosure.

### DETAILED DESCRIPTION

The tire of the present disclosure can be used for any type of tire, but can suitably be used for passenger car tires.

The following is illustrative descriptions of embodiments of the tire according to the present disclosure, with reference to the drawings. In each figure, common components are given the same reference numerals.

### First Embodiment

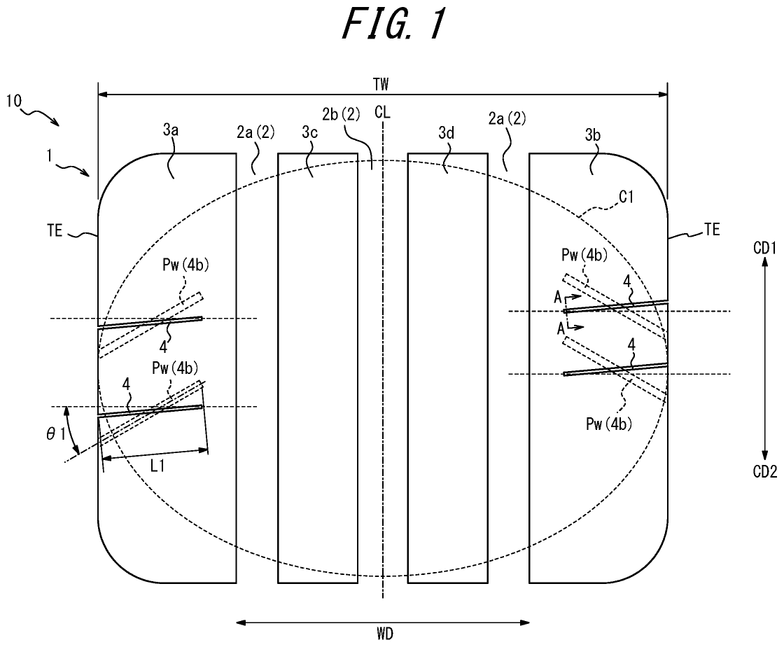

FIG. 1 schematically illustrates the contact patch of a tire 10 according to the first embodiment of this disclosure, viewed in the tire axial direction. In FIG. 1, the grooves in a plan view of the tread surface 1 when tire wear has progressed are also indicated by dotted lines. Also, in FIG. 1, the outer contour line of the contact patch when tire wear has progressed is schematically indicated by the dotted line C1.

As used herein, the term “tread surface (1)” means the outer circumferential surface of the tire that is in contact with the road surface when the tire is assembled on a rim, filled with prescribed internal pressure, and rolled under a maximum load.

In this document, the term “tread edge (TE)” means the outer edge of the tread surface (1) in the tire width direction.

As used herein, the term “rim” refers to the standard rim in the applicable size (Measuring Rim in ETRTO's STANDARDS MANUAL and Design Rim in TRA's YEAR BOOK) as described or as may be described in the future in the industrial standard, which is valid for the region in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States (That is, the term “rim” includes current sizes as well as future sizes to be listed in the aforementioned industrial standards. An example of the “size as described in the future” could be the sizes listed as “FUTURE DEVELOPMENTS” in the ETRTO 2013 edition). For sizes not listed in these industrial standards, the term “applicable rim” refers to a rim with a width corresponding to the bead width of the pneumatic tire.

Also, the term “prescribed internal pressure” refers to the air pressure (maximum air pressure) corresponding to the maximum load capacity of a single wheel in the applicable size and ply rating, as described in the aforementioned JATMA YEAR BOOK and other industrial standards. In the case that the size is not listed in the aforementioned industrial standards, the “prescribed internal pressure” refers to the air pressure (maximum air pressure) corresponding to the maximum load capacity specified for each vehicle in which the tire is mounted.

The term “maximum load” refers to the load corresponding to the above maximum load capacity.

The air here can be replaced by inert gas such as nitrogen gas or other inert gas.

In this document, unless otherwise noted, the dimensions of each element such as grooves and land portions, ground width (TW), etc., shall be measured in the “reference condition” described below.

As used herein, the term “reference condition” refers to the condition in which the tire is assembled on the rim, filled with the above prescribed internal pressure, and unloaded.

In this document, the term “groove width” refers to the distance between a pair of mutually opposing groove wall surfaces when measured perpendicularly to the extending direction of the groove. As used herein, the term “groove depth” refers to the distance from the tread surface to the groove bottom position in a cross-section along the groove width direction, in the direction perpendicular to the tread surface.

Also, in this document, the term “contact patch” shall mean the outer surface of the tire that contacts the road surface when the tire is assembled on the rim, filled with the prescribed internal pressure, and grounded with the maximum load applied.

As used herein, the term “tire circumferential direction” is also referred to as “tire circumferential direction CD1” or “tire circumferential direction CD2”, and the term “tire width direction” is also referred to as “tire width direction WD”. In each figure, the tire circumferential direction (CD) is indicated by the arrows CD1 and CD2, and the tire width direction (WD) is indicated by the arrow WD.

As illustrated in FIG. 1, the tire 10 according to the first embodiment of this disclosure has a plurality of circumferential main grooves 2 extending in the tire circumferential direction on the tread surface. In this embodiment, a pair of circumferential main grooves 2a arranged at the outermost sides in the tire width direction and a circumferential main groove 2b extending along the tire equatorial plane CL are arranged. In the example illustrated in FIG. 1, the number of circumferential main grooves 2 is three, but it can be two or four or more.

In the tread plane view of the tread surface 1 of the tire 10 according to this embodiment, both circumferential main grooves 2a and 2b extend without inclination with respect to the tire circumferential direction, but at least one circumferential main groove 2 may extend at an angle with respect to the tire circumferential direction. In such a case, the circumferential main groove may extend at an angle of, for example, 5° or less with respect to the tire circumferential direction. In addition, each circumferential main groove 2 may extend in a straight line along the tire circumferential direction, as illustrated in FIG. 1, or it may extend circumferentially in a zigzag or wavy shape, etc.

The widths of the circumferential main grooves 2a and 2b are not limited, however, from the viewpoint of drainage performance and steering stability, it is preferable that the grooves be configured so that, for example, when the tire is mounted on the rim, filled with the prescribed internal pressure, and subjected to the maximum load, the pair of opposing groove walls do not come into contact with each other immediately under the load. More specifically, the groove width in the reference condition is preferably greater than 1.5 mm.

Also, the groove depths of the circumferential main grooves 2a and 2b are also not limited, however, from the viewpoint of sufficient drainage performance and maintenance of tire rigidity, for example, it is preferable that the groove depth be 3 mm or more and 20 mm or less.

On the tread surface 1 of the tire 10 of this embodiment, shoulder land portions 3a and 3b are divided by the pair of circumferential main grooves 2a located at the outermost side in the tire width direction, and the tread edges TE; and center land portions 3c and 3d are divided by the circumferential main groove 2b and the pair of circumferential main grooves 2a.

In the tire 10 of this embodiment, the shoulder land portions 3a and 3b and the center land portions 3c and 3d are rib-like land portions that are not divided in the tire circumferential direction, but can be block-like land portions divided by width direction grooves.

In the example illustrated in FIG. 1, the center land portions 3c and 3d do not have grooves or the like extending in the tire width direction, but grooves or the like extending in the tire width direction can be provided as appropriate.

In the tire 10 of this embodiment, at least one shoulder groove 4 is provided in the shoulder land portions 3a and 3b, respectively. In FIG. 1, the shoulder grooves 4 are provided within a contact patch, two each in the shoulder land portions 3a and 3b, but the number and arrangement of the shoulder grooves 4 are not limited. For example, only one of the shoulder land portions 3a and 3b may have the shoulder groove 4.

Further details of the shoulder groove 4 are described below with reference to FIGS. 1, 2, and 3, using the shoulder groove 4 in the shoulder land portion 3a as a typical example.

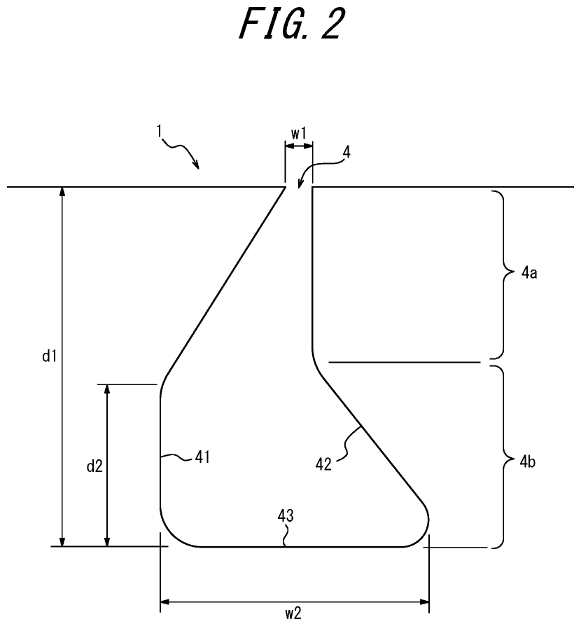

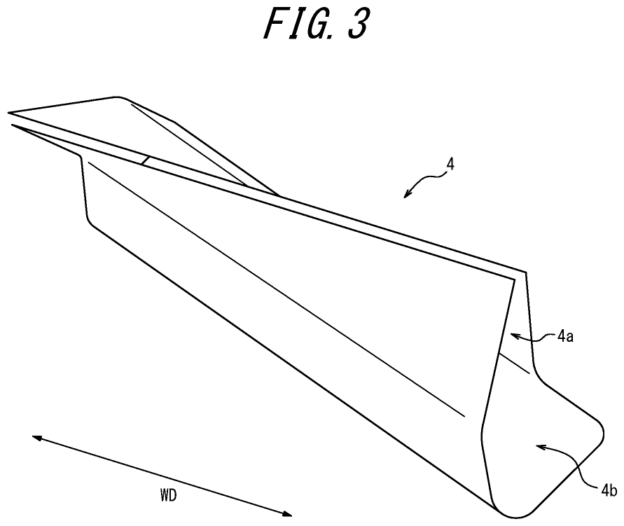

FIG. 2 is a cross-sectional view along the line A-A in FIG. 1, and FIG. 3 is a schematic perspective view for explaining the shape of the shoulder groove.

In this embodiment, the shoulder groove 4 extends along the tire width direction WD on the tread surface 1. Here, extending “along the tire width direction” means that the shoulder groove 4 is parallel to the tire width direction WD in the tire plane view, or the shoulder groove 4 extends at an angle of 5° or less with respect to the tire width direction. The shoulder groove 4 may extend in a straight line in the tire width direction as illustrated in FIG. 1, or it may extend in a zigzag or wavy pattern, etc. in the tire width direction. Here, “zigzag pattern in the tire width direction” means that each of the linear portions constituting the zigzag pattern extends along the tire width direction.

In the example illustrated in FIG. 1, the shoulder groove 4 opens at the tread edge TE of the shoulder land portion 3a, extends toward the circumferential main groove 2a, and terminates in the shoulder land portion 3a. However, the configuration of the shoulder groove 4 is not limited to this, for example, it may open to both the tread edge TE and the circumferential main groove 2a.

Note, that the groove width of the shoulder groove 4 at the tread surface 1 is not particularly limited.

The shoulder groove 4 has a widened section on the groove bottom side where the groove width is larger than that on the tread surface 1 side. As illustrated in FIG. 2, this embodiment has a first widened section 4a on the groove bottom 43 side (in the example illustrated in the figure, in the bottom direction of the paper), where the groove width is larger than that of the tread surface 1 side; and a second widened section 4b on the groove bottom side than the first widened section 4a, where the groove width is larger than that on the first widened section 4a. The shape of the first widened section 4a and 4b is not limited to a particular shape.

For example, as illustrated in FIG. 2, the first widened section 4a may be shaped so that the groove width increases in steps from the tread surface 1 toward the second widened section 4b side, or the groove 4 may have a constant groove width without widening from the tread surface 1 to the second widened section 4b.

In addition, as illustrated in FIG. 2, the groove 4 may be shaped in a cross-sectional view to have a maximum width portion near the groove bottom 43, with the groove width increasing in steps from the tread surface 1 side to the groove bottom 43 side. The shape of the second widened section 4b is not limited, and the cross-sectional shape of the second widened section 4b may be rectangular or otherwise have a constant groove width from the first widened section 4a side to the groove bottom 43. In addition, the cross-sectional shape of the second widened section 4b may be circular or elliptical, for example, with a maximum width portion halfway from the first widened section 4a side to the groove bottom 43 side.

The shoulder groove 4 may have the boundaries of the groove walls 41 and 42 and the groove bottom 43 as arc-shaped side walls and groove bottom having any radius of curvature, as illustrated in FIG. 2, or the groove walls 41 and 42 and the groove bottom 43 may each be straight in a cross section perpendicular to the extending direction of the groove.

As mentioned above, in the tire 10 of the first embodiment, the shoulder groove 4 extends along the tire width direction WD on the tread surface 1, as illustrated in FIG. 1. On the other hand, as illustrated by the dotted line in FIG. 1, the maximum width portion Pw in the tire radial direction of the second widened section 4b of the shoulder groove 4 is configured so that the inclination angle θ1 with respect to the tire width direction WD is 25° or more in a plane view of the tread surface 1 (i.e., it extends at an angle of 25° or more with respect to the tire width direction WD).

Here, the maximum width portion (Pw) of the second widened section 4b means the portion of the shoulder groove 4 where the distance between a pair of mutually opposing groove wall surfaces when measured, in the reference condition, perpendicular to the extending direction of the second widened section 4b is the largest.

In addition, the inclination angle θ1 of the maximum width portion Pw in a plan view of the tread surface 1 means the inclination angle of the line segment connecting one end of the shoulder groove 4 (in the example illustrated in FIG. 1, the one end in the tire width direction) and the other end of the shoulder groove 4 (in the example illustrated in FIG. 1, the other end in the tire width direction) with respect to the tire width direction WD, as illustrated in FIG. 1 (in the example in FIG. 1, the line segment connecting the center in the groove width direction of one end of the shoulder groove 4 with the center in the groove width direction of the other end of the shoulder groove 4).

As illustrated in FIG. 3, in the tire 10 of this embodiment, the shoulder groove 4 extends along the tire width direction WD at the tread surface 1 and continuously changes its inclination angle with respect to the tire width direction WD from the tread surface 1 toward the groove bottom side, so that the inclination angle θ1 is to be 25° or more. The shoulder groove 4 is not limited to this configuration and may be configured so that the portion from the tread surface 1 to the second widened section 4b extends along the tire width direction WD and the second widened section 4b extends at a constant inclination angle θ1. Also, the shoulder groove 4 may be configured to have a stepwise angle change from the tread surface 1 to the groove bottom.

The effects of the tire of the first embodiment are described below.

According to the tire 10 of this embodiment, drainage performance can be ensured by disposing the shoulder grooves 4 extending along the tire width direction WD on the tread surface 1 in the shoulder land portions 3a and 3b which are located on the outermost side in the tire width direction. Since the shoulder groove 4 extends along the tire width direction WD, the tire 10 will be grounded along the contour line of the stepping-in side of the ground contact patch when the tire 10 is moving straight ahead, thereby reducing uneven wear and noise generation at the edge of shoulder groove 4.

In addition, the shoulder groove 4 has the widened section (in this embodiment, the first widened section 4a and the second widened section 4b) on the groove bottom side, where the groove width is larger than that on the tread surface 1 side, thus ensuring sufficient drainage performance when tire wear has progressed.

Furthermore, the shoulder groove 4 is inclined at more than 25° with respect to the tire width direction WD when tire wear has progressed. When tire wear has progressed, the outer contour line of the contact patch changes from the state before wear progressed, as illustrated by the dotted line C1 in FIG. 1. The drainage performance of the grooves tends to increase as the grooves extend in a direction perpendicular to the outer contour line of the contact patch at a position closer to the stepping-in side of the tire. Therefore, in this embodiment, as illustrated in FIG. 1, the shoulder groove 4 extends along the tire width direction before tire wear progresses, and the shoulder groove 4 (the second widened section 4b in this embodiment) extends at an angle of 25° or more with respect to the tire width direction after tire wear has progressed. This promotes, after tire wear has progressed, drainage from the inside in the tier width direction toward the tread edge TE side of the tire, at the timing that the groove is approximately perpendicular to the outer contour line of the ground contact patch, when the shoulder groove 4 is closer to the stepping-in side of the tire as the tire rotates. In addition, by providing the shoulder grooves 4 in the shoulder land portion, drainage toward the tread edge TE is more easily facilitated than when they are disposed in the center land portion, and sufficient drainage performance can be ensured when tire wear has progressed.

The following is a description of suitable configurations, variations, etc., of the tire of the first embodiment.

The groove depth d1 of the shoulder groove 4 is not particularly limited, but from the viewpoint of ensuring sufficient drainage performance and maintaining tire rigidity, it is preferable to make it as deep as the circumferential main grooves 2a and 2b. More specifically, the groove depth d1 is preferably, for example, 3 mm or more and 20 mm or less. More preferably, it is 5 mm or more and 10 mm or less.

The length d2 of the second widened section 4b of the shoulder groove 4 in the groove depth direction is not particularly limited, but from the viewpoint of maintaining sufficient rigidity of the shoulder land portion where the shoulder groove 4 is provided while effectively ensuring sufficient drainage performance, the length d2 is preferably 30% or more and 70% or less of the overall depth d1 of the shoulder groove 4. More preferably, the length d2 is 40% or more and 60% or less of the groove depth d1.

The groove width w1 of the shoulder groove 4 on the tread surface 1 is not particularly limited, but from the viewpoint of effectively maintaining the rigidity of the tire when new, it is suitable to be less than 1.5 mm in the reference condition. From the standpoint of ensuring sufficient drainage performance of the shoulder groove 4, it is suitably at least 1 mm.

The groove width w2 of the maximum width portion Pw of the second widened section 4b of the shoulder groove 4 is not particularly limited, but from the viewpoint of sufficient drainage performance when tire wear has progressed, for example, the groove width w2 can be 1.5 mm or more, and from the viewpoint of maintaining sufficient rigidity of the shoulder land portion in which the shoulder groove 4 is provided, for example, it is suitably 4 mm or less. More suitably, the groove width w2 is 2.0 mm or more and 3.5 mm or less from the viewpoint of both sufficient drainage performance and maintaining the rigidity of the land portions when tire wear has progressed.

The extension length L1 of the shoulder groove 4 on the tread surface 1 is not particularly limited, but is preferably at least 25% of the ground contact width TW of the tire. By setting the extension length L1 to 25% or more of the ground contact width TW of the tire, water from the road surface can be fully captured in the grooves and sufficient drainage performance can be effectively ensured.

The number of the shoulder grooves 4 is not particularly limited, but from the viewpoint of ensuring sufficient drainage performance, it is preferable that two or more grooves are arranged on the shoulder land portions 3a and 3b, respectively, within the contact patch of the tire. More preferably, from the viewpoint of ensuring sufficient drainage performance and rigidity of the land portion where the shoulder grooves 4 are provided, three to ten grooves are preferably arranged in the shoulder land portions 3a and 3b, respectively, within the contact patch.

Here, the term “arranged within the contact patch” shall mean that the shoulder groove 4 is arranged within the contact patch if any part of the shoulder groove 4 is located within the contact patch.

The inclination angle (angle on the acute side) 01 of the maximum width portion Pw in the tire radial direction of the second widened section 4b of the shoulder groove 4 with respect to the tire circumferential direction WD in a plan view of the tread surface 1 is not particularly limited as long as it is 25° or more, but it is preferably 50° or less in order to effectively ensure sufficient drainage performance while maintaining the sufficient circumferential traction performance of the tire. More suitably, the inclination angle θ1 of the second widened section 4b is 28° or more and 45° or less.

Although the direction of rotation of the tire 10 is not particularly limited, it is preferable that the tire 10 be mounted so that it rotates in the direction of tire circumferential direction CD1 in FIG. 1, or that the tire 10 is a tire which is specified or recommended to be mounted to rotate in that direction, to promote more effective drainage from the inside edge in the tire width direction of the shoulder groove 4 to the tread edge TE side when tire wear has progressed. In the example in FIG. 1, this means, after the tire wear progresses, that the tire is rotated so that the maximum width portion Pw slopes from the stepping-in side to the kicking-out side of the tire as it moves from the inside to the outside of the tire width direction. Such mounting promotes more effective drainage by the second widened section 4b of shoulder groove 4 from the stepping-in side to the kicking-out side of the contact patch of the tire. Furthermore, after the tire wear progresses, the grooves will be sloped and extending in the direction of water drainage from the stepping-in side of the contact patch of the tire, which will provide sufficient wet grip with the road surface.

### Second Embodiment

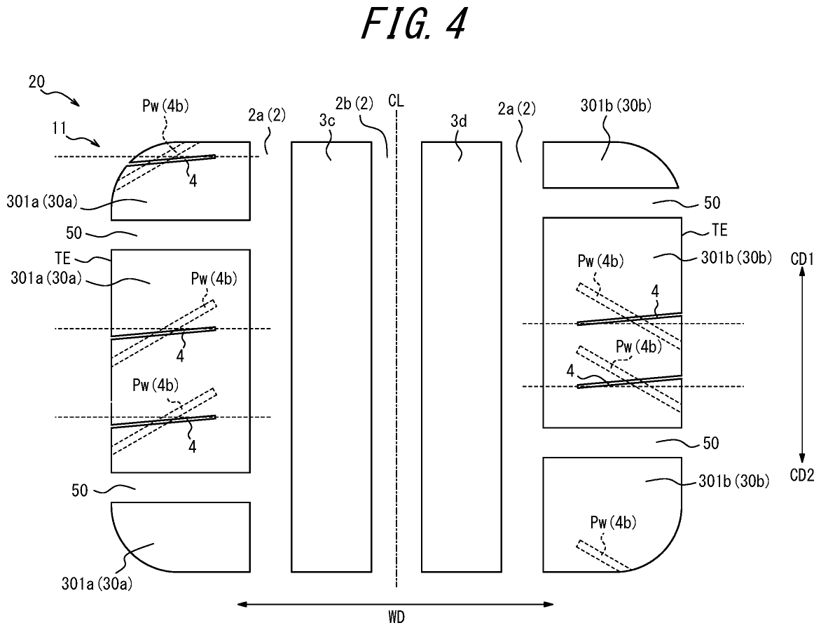

Next, the tire according to the other embodiment of this disclosure (the second embodiment) is described with reference to FIG. 4. The tire 20 of the second embodiment has the same configuration as the tire of the first embodiment, except that the shoulder land portion has a different configuration. Therefore, the components similar to those in the first embodiment are given the same reference numerals and their descriptions will be omitted.

FIG. 4 schematically illustrates the contact patch of a tire 20 according to the second embodiment of this disclosure. In FIG. 4, the grooves in a plan view of the tread surface 11 when tire wear has progressed are also indicated by dotted lines.

On the tread surface 11 of the tire 20 of this embodiment, shoulder land portions 30a and 30b are divided by the pair of circumferential main grooves 2a located at the outermost side in the tire width direction, and the tread edges TE, and center land portions 3c and 3d are divided by the circumferential main groove 2b and a pair of circumferential main grooves 2a.

The shoulder land portions 30a and 30b are divided into a plurality of block land portions 301a and 301b by a plurality of width direction grooves 50 (in this embodiment, within the contact patch, two of the width direction grooves 50 in the shoulder land portions 30a and 30b, respectively) extending in the tire width direction and connected to the tread edge TE and the circumferential main groove 2a (in this embodiment, there is one block land portion 301a and 301b each in which the entire block land portion is located within the contact patch, and there are two block land portions 301a and 301b each in which a portion of the block land portion is located within the contact patch).

The width direction grooves 50 may extend parallel to the tire width direction WD in the tire plane view, or may extend at an inclination angle of 45° or less with respect to the tire width direction WD. Also, the width direction grooves 50 may extend in a straight line in the tire width direction, as illustrated in FIG. 4, or may extend in a zigzag or wavy pattern, etc. in the tire width direction.

In the tire 20 of this embodiment, the number of block land portions disposed within the contact patch is not particularly limited, but it is preferred that two to ten of the block land portions 301a and 301b are arranged within the contact patch of the tire, respectively. By arranging two or more of the block land portions 301a and 301b within the contact patch, respectively, drainage performance of the tire can be more effectively ensured, and by setting the number of block land portions to 10 or less, respectively, sufficient rigidity of the block land portions can be maintained.

Here, the term “arranged within the contact patch” shall mean that the block land portions 301a and 301b are arranged within the contact patch if any part of the block land portions are located within the contact patch.

In the tire 20 of this embodiment, it is preferable that one or more shoulder grooves 4 are arranged in the block land portions 301a and 301b respectively, from the viewpoint of effectively ensuring sufficient drainage performance when tire wear has progressed. The number of the shoulder grooves 4 is preferably no more than three in the block land portions 301a and 301b respectively, from the viewpoint of maintaining sufficient rigidity of the block land portions where the shoulder grooves 4 are arranged.

### INDUSTRIAL APPLICABILITY

The tire of the present disclosure can be used for any type of tire, but can suitably be used for passenger car tires.

### REFERENCE SIGNS LIST

1, 11 Tread surface
2, 2a, 2b Circumferential main groove
3a, 3b, 30a, 30b Shoulder land portion
3c, 3d Center land portion
4 Shoulder groove
4a Widened section
4b Narrowed groove section
10, 20 Tire
41, 42 Groove wall
43 Groove bottom
50 Width direction groove
301a, 301b Block land portion
Pw Maximum width portion
WD Tire width direction
CD1, CD2 Tire circumferential direction
TE Tread edge

1. A tire having a plurality of circumferential main grooves extending in the tire circumferential direction on a tread surface,
at least one shoulder groove is provided in a shoulder land portion, which is divided by the circumferential main groove located at the outermost side in the tire width direction and a tread edge,
the shoulder groove has a widened section on the groove bottom side where a groove width is larger than that on the tread surface side,
the shoulder groove extends along the tire width direction on the tread surface, and
a maximum width portion in the tire radial direction of the widened section extends at an angle of 25° or more with respect to the tire width direction in a plane view of the tread surface.

2. The tire according to claim 1, wherein a groove width on the tread surface of the shoulder groove is less than 1.5 mm.

3. The tire according to claim 1, wherein extension length on the tread surface of the shoulder groove is 25% or more of a ground contact width of the tire.

4. The tire according to claim 1, wherein three to ten of the shoulder grooves are arranged in the shoulder land portion within a contact patch of the tire.

5. The tire according to claim 1, wherein the shoulder land portion is divided into a plurality of block land portions by a plurality of width direction grooves extending in the tire width direction and connected to the tread edge and the circumferential main groove, and
two to ten of the block land portions are arranged within a contact patch of the tire.

6. The tire according to claim 5, wherein one to three of the shoulder grooves are arranged in each of the block land portions.

7. The tire according to claim 2, wherein extension length on the tread surface of the shoulder groove is 25% or more of a ground contact width of the tire.

8. The tire according to claim 2, wherein three to ten of the shoulder grooves are arranged in the shoulder land portion within a contact patch of the tire.

9. The tire according to claim 3, wherein three to ten of the shoulder grooves are arranged in the shoulder land portion within a contact patch of the tire.

10. The tire according to claim 2, wherein the shoulder land portion is divided into a plurality of block land portions by a plurality of width direction grooves extending in the tire width direction and connected to the tread edge and the circumferential main groove, and
two to ten of the block land portions are arranged within a contact patch of the tire.

11. The tire according to claim 3, wherein the shoulder land portion is divided into a plurality of block land portions by a plurality of width direction grooves extending in the tire width direction and connected to the tread edge and the circumferential main groove, and
two to ten of the block land portions are arranged within a contact patch of the tire.

12. The tire according to claim 4, wherein the shoulder land portion is divided into a plurality of block land portions by a plurality of width direction grooves extending in the tire width direction and connected to the tread edge and the circumferential main groove, and
two to ten of the block land portions are arranged within a contact patch of the tire.
